(19) United States
(12) Patent Application Publication
(10) Pub. No.: US 2009/0248855 A1
(43) Pub. Date: Oct. 1, 2009

(54) METHOD FOR MONITORING WEB PAGE STATISTICS

(75) Inventor: Denilson Nastacio, Apex, NC (US)

Correspondence Address: ZILKA-KOTAB, PC- IBMS, P.O. BOX 721120, SAN JOSE, CA, 95172-1120, US

(73) Assignee: International Business Machines Corporation, Armonk, NY (US)

(21) Appl. No.: 12/060,121

(22) Filed: Mar. 31, 2008

(51) Int. Cl. G06F 15/173

(52) U.S. Cl. 709/224

(57) ABSTRACT

A method includes, at a web server: receiving a request from a web browser for a page; requesting the page from a web application; receiving the requested page from the web application; generating a monitoring script after receiving the request from the web browser for the page, wherein the monitoring script is hardcoded with a reference to the web application; adding the generated monitoring script to the page; sending the page with the script to the web browser, the script executing on a system hosting the web browser for generating statistics; receiving the statistics generated by the script; receiving the reference to the web application with the statistics; and storing the statistics and the reference and an association of the reference with the statistics.

### BACKGROUND

The present invention relates to networks, and more particularly, this invention relates to analyzing data sent via networks.

Many solutions have been attempted in order to allow one to consider data from the client-side of Rich Internet Applications (RIAs) as integral part of the server-side of those applications.

One known solution is to expose “Feedback” forms or “problem submission forms” in the client application and allow users to report errors in a given application. The drawback is that this solution depends on the end-user good will to report the problem and on their accuracy in describing the problem.

Another solution is to monitor the results from the client-side through web page passive monitors, such as Coremetrics Surfaid and Google Analytics, and consider that the data is the actual representation of the solution metrics.

As a drawback, solution administrator and system administrators may have different perspectives on the health of the solution. Whereas the solution administrator may receive an error report indicating a foiled connection from the web page to, let's say, Google maps, the IT administrator is looking at a clean log file for the web server.

Conversely, an IT administrator may be looking at a database warning about connection pools running low while end-users are reporting to the solution administrator that a web 2.0 cloud in their web browser is “frozen”.

Another possibility is to correlate the data from the web tracking datamart (often a 3rd party system from the perspective of an IT administrator) with the management data for the hosting infrastructure. The drawback is that this solution requires the deployment of event correlation engines and corresponding correlation rules.

### SUMMARY

A method includes, at a web server: receiving a request from a web browser for a page; requesting the page from a web application; receiving the requested page from the web application; generating a monitoring script after receiving the request from the web browser for the page, wherein the monitoring script is hardcoded with a reference to the web application; adding the generated monitoring script to the page; sending the page with the script to the web browser, the script executing on a system hosting the web browser for generating statistics; receiving the statistics generated by the script; receiving the reference to the web application with the statistics; and storing the statistics and the reference and an association of the reference with the statistics.

Other aspects, advantages and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWING

FIG. 1 is a method for monitoring web page statistics according to one embodiment.

FIG. 2 is a method for monitoring web page statistics according to another embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

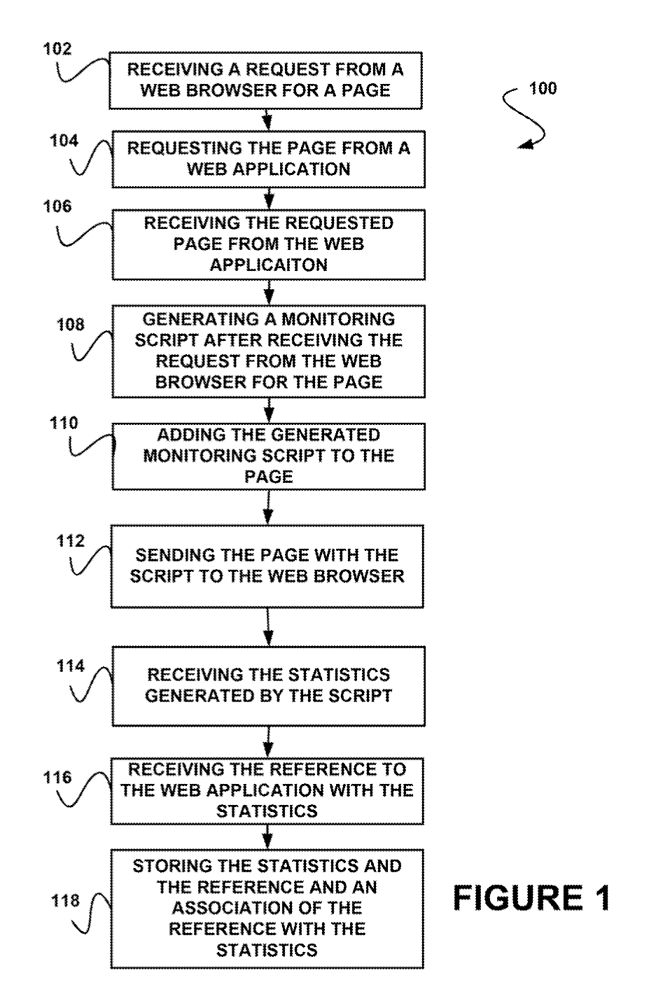

FIG. 1 illustrates a method 100 for monitoring web page statistics, which may be employed in the context of the present invention. The method 100 is performed at a web server. As shown, in operation 102 a request is received from a web browser for a page. Additionally, in operation 104, the page is requested from a web application. Further, in operation 106, the requested page is received from the web application.

Further still in operation 108, a monitoring script is generated after receiving the request from the web browser for the page. Also, the monitoring script is hardcoded with a reference to the web application. In addition, in operation 110, the generated monitoring script is added to the page.

Furthermore, in operation 112, the page is sent with the script to the web browser, where the script is executed on a system hosting the web browser for in order to generate statistics. Further still, in operation 114, the statistics generated by the script are received.

Also, in operation 116, the reference to the web application is received with the statistics. Additionally, in operation 118, the statistics and the reference and an association of the reference with the statistics are stored.

In one embodiment, the request from the web browser for the page may come from a user. For example, the user may enter a web address into the web browser. In another embodiment, the monitoring script may be dynamically generated based on at least one or more elements of the web application. For example, the monitoring script may be programmed to send a web application handle to the web server while reporting statistics to the web server.

In another embodiment, the script may include any script capable of being added to the page. For example, the script may include JavaScript, etc.

In this way, served web pages may be instrumented on the fly so that error entries, statistics entries, etc. may be sent from the client-side to the hosting web server from where the pages were served. This may enable the presentation of a unified view about the health of the web application as perceived by the user.

Additionally, in one embodiment, a system administrator may be able to respond to server-side errors as well as to problems triggered by application logic, mismatched web 2.0 widgets (e.g., when a web mashup references a UI widget from a provider and the provider updates the widget), statistics, etc.

Further, as a result, the instrumentation of existing web servers may include the ability to add error monitoring scripts, statistics monitoring scripts, etc. to all pages served to users. The monitoring script is hardcoded with the reference to the web application so that the reference may be passed back to the web server upon reporting of errors, statistics, etc.

In another embodiment, once errors, statistics, etc. are reported back to the web server, the web application reference in the request may be matched against one or more web handles for existing web applications. Additionally, matches may be stored in/reported to log files as if the web application itself had reported them.

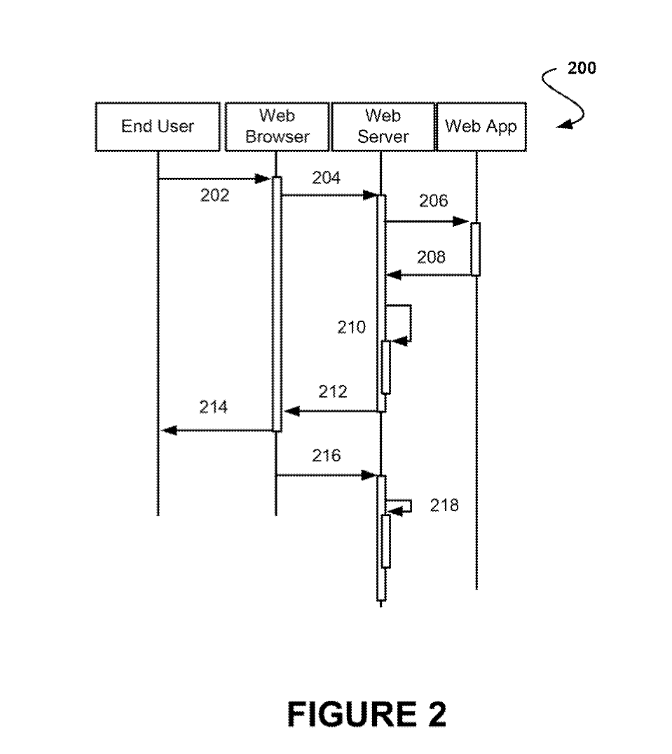

By way of example, FIG. 2 illustrates a method 200 for monitoring web page statistics according to another embodiment. As shown, the process starts with an end user requesting a web page in 202 via a web browser. The web server receives a request for a page in 204 and requests a page from a web application in 206. The web server receives the requested page from the web application in 208, and adds monitoring script in 210. The web server then forwards the page and monitoring script to the web browser in 212, and the web browser outputs the page to the end user in 214. The monitoring script sends statistics back to the web server, which are received in 216. The web server aggregates the statistics in 218.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method, comprising:
at a web server:
receiving a request from a web browser for a page;
requesting the page from a web application;
receiving the requested page from the web application;
generating a monitoring script after receiving the request from the web browser for the page, wherein the monitoring script is hardcoded with a reference to the web application;
adding the generated monitoring script to the page;
sending the page with the monitoring script to the web browser, the monitoring script executing on a system hosting the web browser for generating statistics;
receiving the statistics generated by the monitoring script;
receiving the reference to the web application with the statistics; and
storing the statistics and tile reference and an association of the reference with the statistics.
